(19) United States
(12) Patent Application Publication
(10) Pub. No.: US 2004/0174121 A1
(43) Pub. Date: Sep. 9, 2004

(54) Discharge bulb

(75) Inventors: Toshiaki Tsuda, Shizuoka (JP); Masao Kinoshita, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: KOITO MANUFACTURING CO., LTD.

(21) Appl. No.: 10/750,858

(22) Filed: Jan. 5, 2004

(30) Foreign Application Priority Data
Jan. 10, 2003 (JP) P.2003-4987

(51) Int. Cl. H01J 17/16

(52) U.S. Cl. 313/635

(57) ABSTRACT

In a discharge bulb, an arc tube is fixed and held by an insulating base in the rear side such that the arc tube elongates forward. In the arc tube, an enclosed space is formed by sealing both ends of a straight cylindrical ceramic light emitting tube, electrodes are opposingly disposed therein, and the enclosed space is filled with a light emitting substance and starting rare gas. A light blocking film is disposed in part of a glass shroud surrounding the arc tube that corresponds to a sealed rear portion. To design effective reflecting surfaces, a rectangular light source image is projected onto a luminous distribution screen. Particularly, an upper end portion close to a horizontal cutoff line in the rectangular light source image projected in the vertical direction is clear. Even when the radially projected light source image approaches the elbow portion, a glare-free luminous distribution is formed.

The present application claims benefit and priority from the following application: Japanese Patent Application No. JP 2003-004987, filed Jan. 10, 2003, the contents of which is incorporated herein by reference.

### FIELD OF THE INVENTION

The present invention relates to a discharge bulb for an automotive headlamp, and more particularly, to a discharge bulb comprising an arc tube in which both ends of a straight cylindrical ceramic light emitting tube are sealed, electrodes are opposingly disposed in the light emitting tube, and the light emitting tube is filled with a light emitting substance and a starting rare gas.

### RELATED ART

In a related art discharge bulb serving as a light source of an automotive headlamp, as shown in FIG. 15, an arc tube body 1 includes a glass shroud 4 welded and integrated with an arc tube 2 that is configured as a light emitting tube made of glass. The arc tube body 1 is attached and integrated with a synthetic resin insulating base 9 in the rear side, and fixed and held in such a manner that the arc tube body forward elongates.

Specifically, the rear end side of the arc tube body 1 is grippingly fixed to the front face side of the insulating base 9 via a metal member 5, and the front end side of the arc tube body 1 is supported by a lead support 6 which functions as a conductive path elongating from the insulating base 9.

The related art arc tube 2 is structured so that both ends of a glass tube are sealed. A hermetically enclosed glass bulb 2a is filled with a light emitting substance (i.e., a metal halide) and a starting rare gas, and electrodes are opposingly disposed. The glass bulb 2 is formed in a generally middle portion in the longitudinal direction of the glass tube. The arc tube emits light by means of a discharge between the opposed electrodes. A luminous distribution-controlling light blocking film 7 disposed on an outer side surface of the cylindrical glass shroud 4 has a UV cutoff function. The light blocking film 7 is welded and integrated with the arc tube 2. This light blocking film 7 is used for blocking a part of light advancing toward an effective reflecting surface 8a of a reflector 8, to form a definite clear cutoff line.

However, the foregoing related art has various problems and disadvantages. For example, but not by way of limitation, the related art glass arc tube 2 is corroded by the filling metal halide. As a result, blackening and devitrification occur. Thus, adequate luminous distribution cannot be obtained, and the bulb life is not very long.

To overcome the foregoing problems, a related art arc tube 110 having the following structure has been proposed in Japanese Patent Application publication JP-A-2001-76677, at paragraph 0005 and FIG. 5 . The contents of JP-A-2001-76677 is incorporated herein by reference.

In that related art arc tube shown in FIG. 16, an enclosed space is formed in the arc tube by sealing both ends of a straight cylindrical light emitting tube 120 made of ceramics via cylindrical insulators 130, and electrodes 140 are opposingly disposed in the light emitting tube 120. The enclosed space is filled with a light emitting substance and a starting rare gas. The ceramic light emitting tube 120 is stable for a metal halide, and has a life longer than that of a glass arc tube.

In an arc tube configured by such a straight cylindrical light emitting tube made of ceramics, however, there arises a problem in that only luminous distribution of a low forward visibility in which the hot zone is largely lower than the horizontal cutoff line is obtained.

Usually, an automotive headlamp is structured so that a low beam is formed by an effective reflecting surface in a reflector at a level higher than at least the placement position of a bulb. An effective reflecting surface of a reflector is designed in the following manner. A rectangular light source image corresponding to the light emitting tube 120 is projected radially and is centered at an elbow portion of a clear cutoff line, onto a luminous distribution screen in front of the reflector.

With respect to the horizontal direction, for example, laterally adjacent light source images are projected to partially overlap with each other, as indicated by the symbol A1 in FIG. 17. With respect to the vertical (oblique) direction, vertically (obliquely) adjacent light source images are projected so as to partially overlap with each other as indicated by the symbol B1 (or C1) in FIG. 17. To improve the remote visibility of the driver, it is preferable to place the hot zone HZ as close as possible to the horizontal cutoff line CLH. Particularly, the design of the luminous distribution (in which the effective reflecting surface of the reflector is designed) is conducted so that a vertically projected light source image is placed in the vicinity of the horizontal cutoff line CLH.

In a longitudinal end portion 120a of the light emitting tube 120, light guided by the light guiding function of the wall of the ceramic light emitting tube is emitted as a dull glow. When the luminous distribution is designed so that the light source image which is vertically projected is placed in the vicinity of the horizontal cutoff line CLH as shown in FIG. 18, the dull glowing light source image is projected upward from the horizontal cutoff line CLH as indicated by Pb2, to form a glare light.

Consequently, luminous distribution must be designed so that a light source image which is vertically projected is slightly downward, and separated from the horizontal cutoff line CLH, as shown in FIG. 17. As a result, only luminous distribution of a low forward visibility in which the hot zone is lower than the horizontal cutoff line is obtained.

### SUMMARY OF THE INVENTION

The present invention has been conducted in view of the related art problems. It is an object of the invention to provide a discharge bulb that is most appropriate for the formation of luminous distribution in which a hot zone exists in the vicinity of a horizontal cutoff line, and which is free from glare light. However, the present invention can be accomplished without solving any of the related art problems, or any other problems.

Accordingly, applicant has produced trial products in which a light blocking portion is disposed at a position corresponding to a sealed portion of a light emitting tube of an arc tube, the sealed portion being close to a base, and over at least a predetermined range on an upper side of the base in a circumferential direction. Applicant examined the trial products, and determined that a vertically projected end portion of a rectangular light source image is clear without the dull glow, and the end portion is on the side of the horizontal cutoff line. Further, even when a design is conducted so that a light source image which is vertically projected is close to a horizontal cutoff line of a luminous distribution screen, the glare light is not formed.

To attain at least the foregoing object, a discharge bulb is provided in which an arc tube is fixed and held in a manner that the arc tube forward elongates from an insulating base placed behind the arc tube, an enclosed space is formed in the arc tube by sealing both end portions of a straight cylindrical light emitting tube made of ceramics, electrodes are opposingly disposed in the light emitting tube, and the enclosed space is filled with a light emitting substance and a starting rare gas, wherein a light blocking portion is disposed in a place of the arc tube, the place corresponding to at least a rear end sealed portion among front and rear end sealed portions of the light emitting tube, the light blocking portion extending over at least a predetermined range from an upper side in a circumferential direction to both lateral sides.

To attain the object, a discharge bulb is provided in which an arc tube is fixed and held in a manner that the arc tube forward elongates from an insulating base placed behind the arc tube, an enclosed space is formed in the arc tube by sealing both end portions of a straight cylindrical light emitting tube made of ceramics, electrodes are opposingly disposed in the light emitting tube, and the enclosed space is filled with a light emitting substance and a starting rare gas, wherein ultraviolet-ray blocking glass shroud which surrounds the light emitting tube is placed around the arc tube. In the arc tube or/and the glass shroud, a light blocking portion is disposed in a place corresponding to at least a rear end sealed portion among front and rear end sealed portions of the light emitting tube, the light blocking portion extending over at least a predetermined range from an upper side in a circumferential direction to both lateral sides.

In an arc tube having a glass light emitting tube, an arcuate arc generated between the electrodes in a hermetically enclosed glass bulb emits light. By contrast, in an arc tube having a ceramic light emitting tube, the whole light emitting tube emits light in a substantially uniform manner to form a rod-like light emitting portion (straight cylindrical light emitting portion). When an effective reflecting surface of a reflector is to be designed, a light source image projected onto a luminous distribution screen in front of the reflector is formed into a rectangular shape, so that the luminous distribution can be easily controlled by the shape of the reflecting surface of the reflector.

A related art automotive headlamp is structured so that a low beam is formed by an effective reflecting surface formed in a reflector at a higher level than at least the placement position of a bulb. The light blocking portion of the present invention is disposed in a place of the arc tube (for example but not by way of limitation, the arc tube or/and the glass shroud) corresponding to the rear end sealed portion of the light emitting tube functions to clarify the light-dark boundary of an upper end portion of the light source image that is vertically projected onto a luminous distribution screen.

The effective reflecting surface of the reflector is designed in the following manner. A rectangular light source image corresponding to the light emitting tube is projected radially onto a luminous distribution screen in front of the reflector. With respect to the horizontal direction, for example, laterally adjacent light source images are projected so as to partially overlap with each other, as indicated by A in FIG. 4.

With respect to the vertical direction, vertically adjacent light source images are projected to partially overlap with each other as indicated by B in FIG. 4. With respect to an oblique direction, obliquely adjacent light source images are projected to partially overlap with each other as indicated by C (D) in FIG. 4. To improve the remote visibility of the driver, it is preferable to place the hot zone as close as possible to the horizontal cutoff line CLH, and particularly the design of the luminous distribution (in which the effective reflecting surface of the reflector is designed) is conducted so that a vertically projected light source image is placed in the vicinity of the horizontal cutoff line CLH.

In a longitudinal end portion of the related art light emitting tube, light guided by the light guiding function of the wall of the ceramic light emitting tube is emitted as a dull glow. When the luminous distribution is designed so that the vertically projected light source image is placed in the vicinity of the horizontal cutoff line CLH, the dull glowing light source image is upward projected from the horizontal cutoff line CLH to form glare light. Consequently, the luminous distribution must be designed so that the light source image which is vertically projected is slightly downwardly separated from the horizontal cutoff line CLH.

By contrast, in the presently claimed invention, the light blocking portion disposed in a place of the arc tube (for example but not by way of limitation, the arc tube or/and the glass shroud) corresponding to the rear end sealed portion of the light emitting tube clarifies the light-dark boundary of an upper end portion of the light source image, which is vertically projected onto the luminous distribution screen.

Even when the effective reflecting surface of the reflector is designed so that the vertically projected light source image is placed close to the horizontal cutoff line CLH, the dull glowing light source image is not projected upward from the horizontal cutoff line CLH, and does not form glare light, unlike the related art structure. When the effective reflecting surface of the reflector is designed so that the light source image that is vertically projected is placed as close as possible to the horizontal cutoff line CLH, it is possible to obtain a luminous distribution in which the hot zone exists in the vicinity of the horizontal cutoff line CLH, and which is free from glare light.

Preferably, the light blocking portion is disposed in a range from the sealed portion of the light emitting tube to a position where light directed toward the upper effective reflecting surface of the reflector is blocked.

Also, the discharge bulb of the presently claimed invention is configured so that, in the arc tube, a light blocking portion is disposed in a place corresponding to the front end sealed portion of the light emitting tube, the light blocking portion extending over at least a predetermined range from a lower side in the circumferential direction to both lateral sides.

Further, the discharge bulb of the presently claimed invention is configured so that, in the arc tube or/and the glass shroud, a light blocking portion is disposed in a position corresponding to the front end sealed portion of the light emitting tube, the light blocking portion extending over at least a predetermined range from a lower side in the circumferential direction to both lateral sides.

A related art automotive headlamp is structured so that a predetermined low beam having a clear cutoff line is formed by an effective reflecting surface for low-beam formation disposed in a reflector to be higher in level than the insertion attachment position of a bulb. By contrast, in an automotive headlamp structured so that a predetermined low beam having a clear cutoff line is formed by an upper effective reflecting surface of a reflector and a lower effective reflecting surface which is disposed in the reflector to be lower in level than the insertion attachment position of a bulb, it is necessary to consider also luminous distribution formed by the lower effective reflecting surface of the reflector. In the lower effective reflecting surface, the front end portion of the light emitting tube defines an end portion of the light source image on the side of the horizontal cutoff line on a luminous distribution screen. The light blocking portion disposed in a place of the arc tube corresponding to the front end sealed portion of the light emitting tube clarifies the light-dark boundary of an upper end portion of the light source image, which is vertically projected onto the luminous distribution screen.

When the reflector is designed so that the vertically projected light source image is close to the horizontal cutoff line, the dull glowing light source image is not upward projected from the horizontal cutoff line, and does not form glare light, unlike the related art structure.

When the upper and lower effective reflecting surfaces of the reflector are designed so that the light source image which is vertically projected is placed as close as possible to the horizontal cutoff line, it is possible to obtain luminous distribution in which the hot zone exists in the vicinity of the horizontal cutoff line, and which is free from glare light.

Preferably, the front end light blocking portion is disposed in range from the sealed portion of the light emitting tube to a position where light directed toward the lower effective reflecting surface of the reflector can be blocked.

The discharge bulb of the presently claimed invention is configured so that the light blocking portion is formed in a predetermined width from the place corresponding to the sealed portion of the light emitting tube, to a maximum width at a tip end of corresponding one of the electrodes.

The thermal energy of light blocked by the light blocking portion from being emitted from the sealed portion of the light emitting tube functions to suppress lowering of the coldest spot temperature of a root portion of the electrode, thereby enhancing the luminous efficiency of the light emitting tube. Therefore, it is preferable to increase the width in the axial direction of the light blocking portion. To block light from being emitted from the sealed portion, the width in the axial direction of the light blocking portion must be equal to or larger than at least the width of the sealed portion.

When the light blocking portion has a width at which the portion extends beyond the tip end of the electrode, however, the length of the effective light emitting portion is correspondingly shortened, and the area of the effective reflecting surface formable in the reflector is reduced. Thus, luminous distribution of a sufficient light quantity cannot be ensured. Therefore, it is preferable to set the width in the axial direction of the light blocking portion to include the place corresponding to the sealed portion of the light emitting tube, and extending to the tip end of the electrode at the maximum width.

In the presently claimed invention, the discharge bulb is configured so that the light blocking portion on a rear end side of the arc tube or/and the glass shroud extends in the circumferential direction to positions that horizontally coincide in level with an uppermost position of the rear end sealed portion of the light emitting tube.

Lightemitted from the rear end sealed portion of the light emitting tube and directed toward the upper effective reflecting surface of the reflector is blocked by the rear end light blocking portion disposed on the arc tube or/and the glass shroud. Accordingly, an end portion on the side and elbow portion of a clear cutoff line which is the projection center of a rectangular light source image, radially projected onto a luminous distribution screen via the upper effective reflecting surface of the reflector is made clear.

In the presently claimed invention, the discharge bulb is configured so that the light blocking portion on a front end side of the arc tube or/and the glass shroud extends in the circumferential direction to positions which horizontally coincide in level with a lowermost position of the front end sealed portion of the light emitting tube.

Light emitted from the front end sealed portion of the light emitting tube and directed toward the lower effective reflecting surface of the reflector is blocked by the front end light blocking portion disposed on the arc tube or/and the glass shroud. Accordingly, an end portion on the side of an elbow portion of a clear cutoff line which is the projection center of a rectangular light source image, radially projected onto a luminous distribution screen via the lower effective reflecting surface of the reflector, is made clear.

In the claimed invention, the discharge bulb is configured so that the light blocking portion is disposed in the circumferential direction over a whole circumference of the arc tube or/and the glass shroud.

In the related art, it is sufficient for the light blocking portion disposed on the arc tube or/and the glass shroud to be disposed only in a range in the circumferential direction corresponding to the upper or lower effective reflecting surface of the reflector. However, the disposition in only the range in the circumferential direction corresponding to the effective reflecting surface is cumbersome in view of a masking and applying process. Even when the light blocking portion is disposed over the whole circumference of the arc tube or/and the glass shroud, the function that an end portion on the side of an elbow portion of a clear cutoff line of a rectangular light source image, radially projected onto a luminous distribution screen is made clear, remains to be attained. In this case, for example, the cost reduction due to the simplified production steps is greater than the cost increase due to the increased amount of the light blocking material.

Therefore, the presently claimed invention may be advantageous over at least the related art. However, such advantage is not required for the presently claimed invention.

### BRIEF DESCRIPTION OF THE DRAWINGS

The above and other objects and advantages of the present invention will become more apparent by describing in detail exemplary, non-limiting embodiments thereof with reference to the accompanying drawings, wherein like reference numerals designate like or corresponding parts throughout the several views, and wherein:

FIG. 1 is a longitudinal section view showing a state where a discharge bulb of a first, exemplary, non-limiting embodiment of the invention is inserted and attached to a bulb insertion hole of a reflector;

FIG. 2 is an enlarged longitudinal section view of an arc tube body which is a main portion of the discharge bulb, according to an exemplary, non-limiting embodiment of the invention;

FIG. 3 is a perspective view showing an effective reflecting surface of a reflector, and a luminous distribution pattern formed on a luminous distribution screen, according to an exemplary, non-limiting embodiment of the invention;

FIG. 4 is a front view of the luminous distribution screen onto which light source images are projected, according to an exemplary, non-limiting embodiment of the invention;

FIG. 5 is a view showing relationships between the inner diameter of a light emitting tube and a total luminous flux, according to an exemplary, non-limiting embodiment of the invention;

FIG. 6 is a view showing relationships between the length of the light emitting tube and the total luminous flux, according to an exemplary, non-limiting embodiment of the invention;

FIG. 7 is a view showing results of tests in which influences of the length and outer diameter of the light emitting tube on the initial light source performance and the luminous distribution performance of a headlamp were checked, according to an exemplary, non-limiting embodiment of the invention;

FIG. 8 is a view showing the brightness distribution characteristics of a light emitting tube of a parallel light transmittance of 20%, according to an exemplary, non-limiting embodiment of the invention;

FIG. 9 is a view showing the brightness distribution characteristics of a light emitting tube of a parallel light transmittance of 10%, according to an exemplary, non-limiting embodiment of the invention;

FIG. 10 is an enlarged longitudinal section view of an arc tube which is a main portion of a discharge bulb of a second exemplary, non-limiting embodiment of the invention;

FIG. 11 is an enlarged longitudinal section view of an arc tube which is a main portion of a discharge bulb of a third exemplary, non-limiting embodiment of the invention;

FIG. 12 is an enlarged longitudinal section view of an arc tube which is a main portion of a discharge bulb of a fourth exemplary, non-limiting embodiment of the invention;

FIG. 13 is a longitudinal section view of an arc tube body which is a main portion of a discharge bulb of a fifth exemplary, non-limiting embodiment of the invention;

FIG. 14 is a longitudinal section view of the arc tube body (a section view taken along the line XIV-XIV of FIG. 13);

FIG. 15 is a longitudinal section view of a related art discharge bulb;

FIG. 16 is an enlarged longitudinal section view of a ceramic arc tube according to the related art;

FIG. 17 is a front view of a related art luminous distribution screen onto which light source images are projected; and

FIG. 18 is a front view of the related art luminous distribution screen onto which light source images to be formed in the vertical direction are projected while being made close to a clear cutoff line.

### DETAILED DESCRIPTION OF THE INVENTION

Hereinafter, a mode for carrying out the invention will be described by way of embodiments.

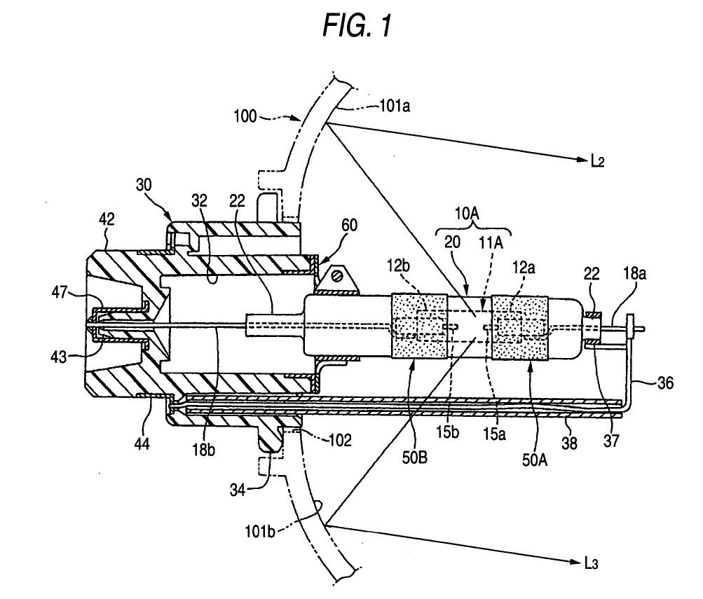

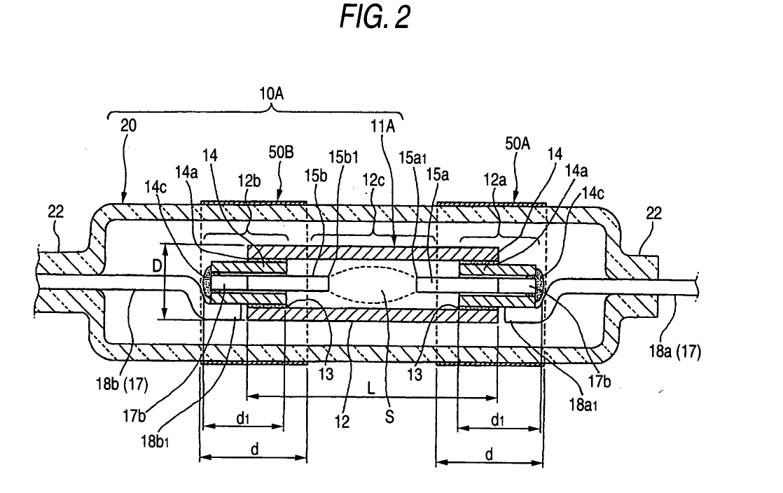

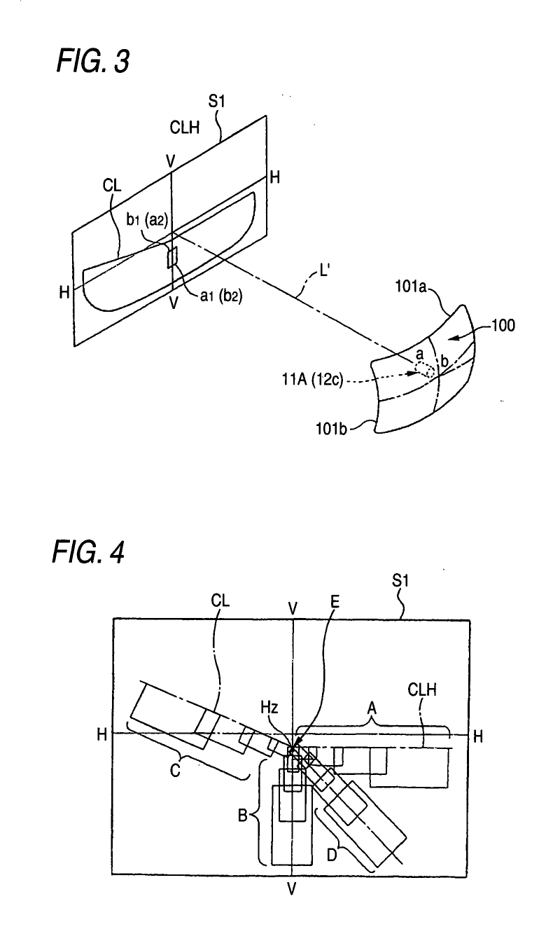

FIGS. 1 to 9 show a first exemplary, non-limiting embodiment of the invention. FIG. 1 is a longitudinal section view showing a state where a discharge bulb of the first embodiment of the invention is inserted and attached to a bulb insertion hole of a reflector, FIG. 2 is an enlarged longitudinal section view of an arc tube body which is a main portion of the discharge bulb, FIG. 3 is a perspective view showing an effective reflecting surface of a reflector, and a luminous distribution pattern formed on a luminous distribution screen, and FIG. 4 is a front view of the luminous distribution screen onto which light source images are projected.

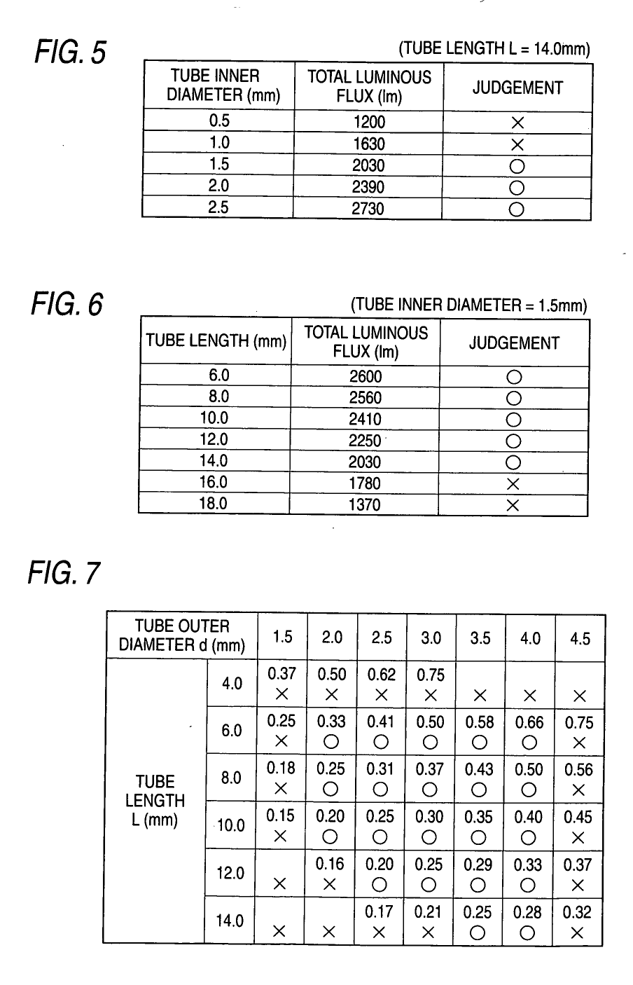

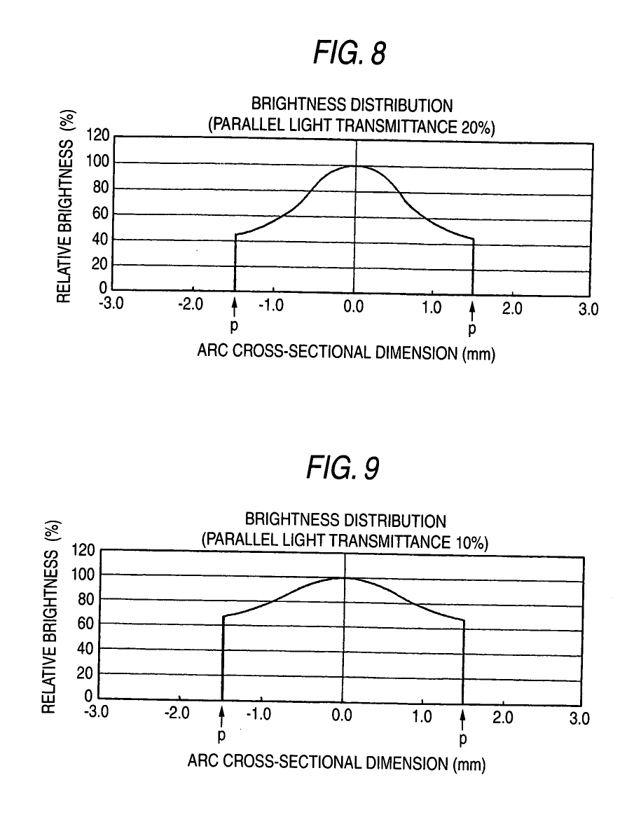

FIG. 5 is a view showing relationships between the inner diameter of a light emitting tube and a total luminous flux, FIG. 6 is a view showing relationships between the length of the light emitting tube and the total luminous flux, FIG. 7 is a view showing results of tests in which influences of the length and outer diameter of the light emitting tube on the initial light source performance and the luminous distribution performance of a headlamp were checked, and FIG. 8 is a view showing the brightness distribution characteristics of a light emitting tube of a parallel light transmittance of 20%. FIG. 9 is a view showing the brightness distribution characteristics of a light emitting tube of a parallel light transmittance of 10%.

An insulating base 30 is made of a PPS resin, and a focusing ring 34 is engaged with a bulb insertion hole 102 of a reflector 100 of an automotive headlamp disposed on the outer periphery. In front of the insulating base 30, an arc tube body 10A is fixedly supported by a metal lead support 36 that is a conductive path elongating forward from the base 30. A metal support member 60 is fixed to the front face of the base 30, thereby constituting a discharge bulb.

A lead wire 18a extending from a front end portion of the arc tube body 10A is fixed by spot welding to a bent tip end portion of the lead support 36 elongating from the insulating base 30. The front end portion of the arc tube body 10A is supported by the bent tip end portion of the lead support 36 via a metal support member 37.

A lead wire 18b extending from a rear end portion of the arc tube body 10A is connected to a terminal 47 disposed in a rear end portion of the insulating base 30. The rear end portion of the arc tube body 10A is gripped by the metal support member 60, which is fixed to the front face of the insulating base 30.

A recess 32 is disposed in a front end portion of the insulating base 30. The rear end portion of the arc tube body 10A is accommodated and held in the recess 32. A columnar boss 43 surrounded by a cylindrical outer tube 42 that is tapered in a rearward direction is formed in the rear end portion of the insulating base 30. A cylindrical belt-type terminal 44 is connected to the lead support 36, and is fixed and integrated with the outer periphery of a root portion of the outer tube 42. A cap-type terminal 47 to which the rear end lead wire 18b is connected is coveringly attached to the boss 43 that is to be integrated with the terminal 47.

The arc tube body 10A has a structure in which a cylindrical ultraviolet-ray blocking glass shroud 20 is placed and integrated to cover an arc tube 11A having an enclosed space S. Electrodes 15a and 15b are paired to be opposed to each other. Lead wires 18a and 18b are electrically connected to electrodes 15a and 15b, which extend into the enclosed space S. The lead wires 18a and 18b extend from front and rear end portions of the arc tube 11A, respectively. The ultraviolet-ray blocking glass shroud 20 is pinch-sealed (sealingly attached) to the lead wires 18a and 18b. Further, the arc tube 11A and the glass shroud 20 are integrated with each other to constitute the arc tube body 10A. A pinch seal portion 22 is formed by reducing the diameter of the glass shroud 20b at a front end thereof.

As shown in FIG. 2 in an enlarged manner, the arc tube 11A is structured so that the enclosed space S is formed by sealing both the ends of a straight cylindrical light emitting tube 12 made of translucent ceramics. The electrodes 15a and 15b are opposed to each other in the light emitting tube 12, and the enclosed space is filled with a light emitting substance (e.g., mercury and a metal halide, but not limited thereto) and a starting rare gas. The lead wires 18a and 18b are joined to front and rear end sealed portions 12a and 12b of the light emitting tube 12, respectively, and elongate coaxially therewith.

Molybdenum pipes 14 are used for sealing end openings of the arc tube 11A (the light emitting tube 12), and fixing and supporting the electrodes 15a and 15b, and metallizing layers 14a join the light emitting tube 12 with the molybdenum pipes 14 to seal the end openings of the light emitting tube. Molybdenum pieces 17a and 17b of a predetermined length are coaxially joined and integrated with the electrodes 15a and 15b, respectively. The molybdenum pieces 17a and 17b are welded to the molybdenum pipes 14, whereby the electrodes 15a and 15b are fixed to the light emitting tube 12 via the molybdenum pipes 14. Laser-welded portions 14c are at the ends of the molybdenum pipes 14. Bent tip end portions 18a1 and 18b1 of the molybdenum lead wires 18a and 18b are fixed by welding to the molybdenum pipes 14 protruding from the front and rear ends of the light emitting tube 12, so that the lead wires 18a and 18b and the electrodes 15a and 15b are on the same axis.

The molybdenum pipes 14 are joined and fixed by metallization to the ends of the light emitting tube 12, and the molybdenum pieces 17a and 17b of the electrodes 15a and 15b, respectively, are welded to the pipes 14 to configure the sealed portions 12a and 12b (the front end sealed portion 12a and the rear end sealed portion 12b) of the light emitting tube 12. Therefore, the sealed portions 12a and 12b of the light emitting tube are end portions of the light emitting tube 12, and which are sealed via the molybdenum pipes 14. More specifically, the sealed area includes the laser-welded portions 14c in the end portions of the light emitting tube 12, which correspond to the lengths of the molybdenum pipes 14.

In the electrodes 15a and 15b, the portions which protrude into the enclosed space S are made of tungsten having excellent heat resistance, and those portions joined to the molybdenum pipes 14 are made of molybdenum, having excellent compatibility with the molybdenum pipes 14. Thus, both the heat resistance of the discharge luminous portions of the electrodes 15a and 15b, and the gas-tightness of the sealed portions of the light emitting tube 12 are satisfied.

The light emitting tube 12 is configured to have a compact shape. The outer diameter is about 2.0 to 4.0 mm, the length is about 8.0 to 12.0 mm, and the dimension ratio d/L of the outer diameter d to the length L is in the approximate range of 0.2 to 0.5, ensure the heat resistance and the durability. These dimensions enable the whole arc tube 11A (the light emitting tube 12) to emit light in a substantially uniform manner.

FIGS. 5, 6, and 7 show relationships between the inner diameter of the light emitting tube and a total luminous flux, the length of the light emitting tube and the total luminous flux, and influences of the length and outer diameter of the light emitting tube on the initial light source performance and the luminous distribution performance of a headlamp, respectively.

As shown in FIGS. 5 and 7, when the light emitting tube is excessively thin or has an inner diameter smaller than about 1.0 mm and the outer diameter must be smaller than about 1.5 mm, a stable luminous flux of 2,000 lumens or more is not obtained. To obtain a stable luminous flux of 2,000 lumens or more, the inner diameter of the light emitting tube must be about 1.5 mm or larger, and the outer diameter must be about 2.0 mm or larger.

By contrast, when the light emitting tube is excessively thick (the outer diameter is about 4.5 mm or larger), the maximum illuminance in the luminous distribution is lowered, and the maximum illuminance point is lower in level than the horizontal position. Also, the remote visibility is impaired. To prevent the maximum illuminance in the luminous distribution from being lowered, maintain the maximum illuminance point to a vicinity of the horizontal position, and ensure remote visibility, the outer diameter of the light emitting tube must be about 4.0 mm or smaller, as shown in FIG. 7. Consequently, it is preferable to set the outer diameter of the light emitting tube to be in an approximate range of about 2.0 to 4.0 mm, preferably about 2.5 to 3.5 mm.

As also shown in FIG. 6, when the length of the light emitting tube is excessively short (about 4.0 mm or smaller), the light quantity in front of a vehicle is insufficient. When the length is excessively long (about 16.0 mm or larger), the coldest spot temperatures of root portions of the electrodes are lowered, and the luminous efficiency is reduced. Thus, a luminous flux of 2,000 lumens or more cannot be obtained. Consequently, it is preferable to set the length of the light emitting tube to about 6.0 to 14.0 mm, preferably about 8.0 to 12.0 mm.

As shown in FIG. 7, when the size of a cylindrical light emitting tube is identified by the dimension ratio d/L of the outer diameter d to the length L, d/L is preferably in the range of 0.2 to 0.5 to obtain a stable luminous flux of 2,000 lumens or more and provide excellent visibility. In the embodiment, the size (d/L) of the light emitting tube 12 is set to a range of 0.2 to 0.5. In FIG. 7, a decimal value indicates the value of d/L. Also, a case where a stable luminous flux of 2,000 lumens or more is obtained is indicated by a mark of ◯, and a case where a stable luminous flux of 2,000 lumens or more is not obtained is indicated by a mark of

The enclosed space S of the light emitting tube 12 is filled with a light emitting substance such as a metal halide. Unlike glass, the ceramic light emitting tube 12 is substantially nonreactive with the filled substances. In the arc tube 11A, therefore, deterioration with time such as devitrification, a reduction of the luminous flux, and a change of chromaticity which are observed in the related art glass arc tube can be suppressed.

Since the enclosed space (discharge space) S is small, an arc generated between the electrodes 15a and 15b has a linear shape which elongates along the wall of the straight cylindrical light emitting tube 12, as shown in FIG. 2. The brightness and color of the arc are varied depending on the distance from the arc center. The light emitting tube 12, which is made of translucent ceramics, is opalescent and has a function of diffusing emitted light. When an arc is transmitted through the opalescent light emitting tube, the differences in brightness and color are flattened, so that the whole light emitting tube 12 uniformly emits light to obtain a light emitting portion free from uneven brightness and uneven color.

The glass shroud 20 is configured by quartz glass into which TiO₂, CeO₂, and the like are doped. The glass shroud 20 has a function of blocking ultraviolet rays, so as to substantially prevent emission of ultraviolet rays at a wavelength harmful to the human body from the light emitting tube 12 serving as a discharging portion.

The interior of the glass shroud 20 is set to a vacuum state or a inert gas-filled state, and designed to exert a heat insulating function with respect to radiation of heat from the enclosed space S serving as a discharging portion. The lamp characteristics are thus prevented from being affected by a change of the external environment.

In the arc tube 11A, since the whole ceramic light emitting tube 12 emits light by an arc generated between the electrodes, the luminous distribution is formed (effective reflecting surfaces 101a and 101b of the reflector are designed) while considering the light emitting tube 12 as the light source. For example, but not by way of limitation, when a predetermined luminous distribution pattern for a vehicle is to be formed, a rectangular light source image is preferred, and the light emitting tube 12 preferably has a straight cylindrical shape.

In the cylindrical glass shroud 20 surrounding the light emitting tube 12, strip-like light blocking films 50A and 50B are formed by application over the whole circumference at positions of the outer peripheral face corresponding to the sealed portions 12a and 12b, respectively. Each of the light blocking films 50A and 50B has a predetermined width d larger than the width d₁ of the sealed portion 12a or 12b, and at which the films 50A, 50B fail to reach the tip end 15a1 or 15b1 of the electrode 15a or 15b. Each of the films 50A, 50B is configured to block light emitted from the sealed portion 12a or 12b and directed toward the effective reflecting surface 101a or 101b by the guiding function of the wall of the light emitting tube 12.

Since the molybdenum pipes 14, the metallizing layers 14a, and the laser-welded portions 14c are opaque, substantially no light leaks from these members. In the front and rear end portions of the glass shroud 20, the corresponding one of the light blocking films 50A and 50B only extends to a position where the film covers the laser-welded portion 14c.

By contrast, the limits of the light blocking films 50A and 50B on the side of the luminescence center are set as follows. When the limits of the films 50A, 50B exceed the electrode tip ends 15a1 and 15b1, an effective light emitting portion 12c sandwiched between the light blocking films 50A and 50B becomes short, and the quantity of emitted light is reduced. Therefore, the limits are preferably set to positions at which the films cover the sealed portions 12a and 12b and do not exceed the electrode tip ends 15a1 and 15b1.

In the light emitting tube 12, only the region 12c sandwiched between the pair of light blocking films 50A and 50B functions as the light emitting portion. As shown in FIGS. 3 and 4, in designing the effective reflecting surfaces 101a and 101b of the reflector, a light source image projected onto a luminous distribution screen in front of the reflector is formed into a rectangular shape, so that the luminous distribution can be easily controlled by means of the shape of the reflecting surface of the reflector.

As shown in FIG. 1, light emitted from the light emitting tube 12 is reflected by the effective reflecting surfaces 101a and 101b of the reflector 100 as indicated by arrows L2 and L3. As shown in FIG. 4, rectangular light source images gather on a luminous distribution screen S1 placed in front of the reflector 100 as shown in FIG. 3, so that a predetermined luminous distribution pattern (see FIG. 3) having a clear cutoff line CL is formed. In FIG. 3, L′ denotes the optical axis of the reflector 100 (101a and 101b).

Accordingly, the effective reflecting surfaces 101a and 101b of the reflector are designed while a rectangular light source image corresponding to the light emitting region 12c of the light emitting tube 12 is projected radially with being centered at an elbow portion E of the clear cutoff line CL, onto the luminous distribution screen S1 placed in front of the reflector. For example, but not by way of limitation, the effective reflecting surfaces 101a and 101b are designed as follows.

With respect to the horizontal direction, laterally adjacent rectangular light source images are projected to partially overlap each other as indicated by the letter A in FIG. 4. With respect to the vertical direction, vertically adjacent light source images are projected to partially overlap with each other as indicated by the letter B. With respect to an oblique direction, obliquely adjacent rectangular light source images are projected to partially overlap each other as indicated by the letters C and D.

To improve the remote visibility of the driver, it is preferable to place the hot zone HZ at a position which is as close as possible to the horizontal cutoff line CLH. To realize this, the luminous distribution (in which the shapes of the effective reflecting surfaces 101a and 101b are designed) is designed so that light source images projected in various radial directions, particularly those which are vertically projected, are placed in the vicinity of the elbow portion E.

In the non-limiting, exemplary embodiment of the present invention, the light-dark boundaries of the end portions in the longitudinal direction of the rectangular light source images which are projected onto the luminous distribution screen S1 (particularly, the light-dark boundary of the upper end portion of the rectangular light source image which is vertically projected) are made clear by the light blocking films 50A and 50B disposed in the front and rear end portions of the glass shroud 20. Even when the vertically projected light source image is placed close to the elbow portion E of the clear cutoff line CL as indicated by the letter B in FIG. 4, the dull glowing light source image is not projected upward from the horizontal cutoff line, and does not form glare light, as distinguished from the related art structure.

In the non-limiting, exemplary embodiment of the present invention, the effective reflecting surfaces 101a and 101b of the reflector are designed so that the light source images are substantially close to the elbow portion E of the clear cutoff line CL in all radial directions centered at the elbow portion E.

The location of the light image is described in more detail below. As shown in FIGS. 3 and 4, the front and rear ends of the effective light emitting portion 12c of the light emitting tube 12 are indicated by a and b. In a light source image b1a1 (a2b2) of the effective light emitting portion 12c which is radially projected onto the luminous distribution screen S1 by the upper effective reflecting surface 101a, a radially inner end portion b1 (an outer end portion a1) of the light source image corresponds to the rear end b (the front end a) of the effective light emitting portion 12c.

By contrast, in a light source image of the effective light emitting portion 12c which is radially projected onto the luminous distribution screen by the lower effective reflecting surface 101b, a radially inner end portion a2 (an outer end portion b2) of the light source image corresponds to the front end a (the rear end b) of the effective light emitting portion 12c. The rear end b of the effective light emitting portion 12c which provides the radially inner end portion b1 of the rectangular light source image formed by the upper effective reflecting surface 101a is defined by the light blocking portion 50B on the rear end side, which is disposed over the whole circumference of the glass shroud 20.

Therefore, the radially inner end portion b1 of the rectangular light source image b1a1 projected onto the luminous distribution screen is clear. The front end a of the effective light emitting portion 12c which provides the radially inner end portion a2 of the rectangular light source image formed by the lower effective reflecting surface 101b is defined by the light blocking portion 50A on the front end side, which is disposed over the whole circumference of the glass shroud 20. Thus, the radially inner end portion a2 of the rectangular light source image a2b2 projected onto the luminous distribution screen is clear.

In the exemplary, non-limiting embodiment of the present invention, the shapes of the upper and lower effective reflecting surfaces 101a and 101b of the reflector are designed so that the light source image of the effective light emitting portion 12c projected onto the luminous distribution screen S1 is close to the elbow portion E of the clear cutoff line CL. Further, a luminous distribution pattern is formed in which the hot zone Hz is in the vicinity of the horizontal cutoff line CLH, but a dull glowing light source image is not upward projected from the horizontal cutoff line CLH (glare light is not formed), in contrast with the related art structure.

In the direction along the clear cutoff line CL, as indicated by the letter A or C in FIG. 4, side edge portions of the light emitting tube 12 in which the light-dark boundary is clear to some extent are arranged along the clear cutoff line CL. Even when the light source images are placed close to the elbow portion E, the problem of glare light is not caused.

As a result, the headlamp of the embodiment can therefore form luminous distribution of a low beam in which the hot zone Hz exists in the vicinity of the elbow portion E of the clear cutoff line CL, to attain excellent remote visibility of the driver, and which does not form glare light for an oncoming vehicle or the like.

The light emitting tube 12 is configured so that the parallel light transmittance is about 20% or lower, and the total light transmittance is about 85% or higher. Thus, the whole tube uniformly emits light.

In the light emitting tube 12, the total light transmittance is about 85% or higher, and the total luminous flux of about 2,000 lumens or more is obtained. The brightness and color of the arc varies depending on the distance from the arc center. Since the parallel light transmittance of the light emitting tube 12 is about 20% or lower, the translucent ceramic is opalescent and strongly exhibits a function of diffusing emitted light (i.e., has a high diffuse transmittance). When light of an arc is transmitted through the opalescent light emitting tube, the differences in brightness and color are flattened, so that the whole light emitting tube 12 uniformly emits light to obtain a light emitting portion free from uneven brightness and uneven color.

The metal halide 13 in the light emitting tube 12 accumulates in the vicinities of the electrodes 15a and 15b (or, the ends of the light emitting tube), which are the coldest spots in the cylindrical light emitting tube. The yellowish light produced by the metal halide 13 is diluted when passing through the opalescent light emitting tube and diffused at the emission therefrom to be inconspicuous. Therefore, such light does not cause any problem in luminous distribution.

FIGS. 8 and 9 show the brightness distribution characteristics when the ceramic light emitting tube 12 has a parallel light transmittance of 20% and 10%, respectively. The abscissa shows the cross-sectional dimension of an arc. The brightness center of an arc corresponds to the zero (0, 0). The characteristics were checked for a light emitting tube having an outer diameter of about 3.0 mm. When the parallel light transmittance of the light emitting tube is 20% or lower, the diffuse transmittance (the total light transmittance-the parallel light transmittance) is correspondingly high, so that the brightness distribution at the position of the outer peripheral edge of the light emitting tube indicated by the letter P is sharp (clear). Also, unevenesses of brightness and color of an arc through the light emitting tube are not conspicuous.

By contrast, although not shown, when the parallel light transmittance of the light emitting tube is higher than 20%, the diffuse transmittance is correspondingly low, so that the brightness distribution at the position of the outer peripheral edge of the light emitting tube indicated by the letter P is gentle (unclear), and unevenesses of brightness and color of an arc through the light emitting tube are conspicuous.

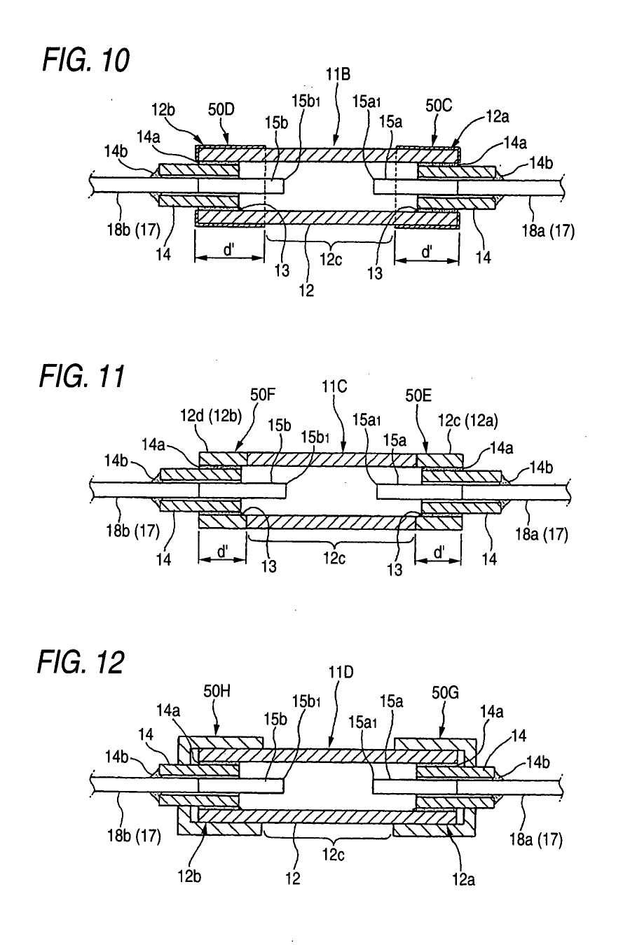

FIG. 10 is an enlarged longitudinal section view of an arc tube which is a main portion of a discharge bulb of a second exemplary, non-limiting embodiment of the invention.

In the first embodiment disclosed above, the light blocking films 50A and 50B are disposed on the glass shroud 20 which surrounds the arc tube. By contrast, in the second embodiment, light blocking films 50C and 50D, which block light leaking from the sealed portions 12a and 12b of the light emitting tube 12, are disposed not on a glass shroud (not shown), but directly on an arc tube 11B.

In the arc tube 11B which is a main portion of the discharge bulb of the second embodiment, the lead wires 18a and 18b join the electrodes 15a and 15b and are welded and fixed to the molybdenum pipes 14, respectively. The reference numeral 14b denotes laser-welded portions. The light blocking films 50C and 50D which block light leaking from the sealed portions 12a and 12b are disposed on front and rear end portions of the arc tube 11B (the sealed portions 12a and 12b of the light emitting tube 12). Each of the light blocking films 50C and 50D has a predetermined width d′ which extends from the end face of the light emitting tube 12 to a position that exceeds the sealed portion between the molybdenum pipe 14 and the light emitting tube 12, and that fails to reach the tip end 15a1 or 15b1 of the corresponding electrode. Therefore, light leaking from the sealed portions 12a and 12b is blocked.

Since the end portions of the light emitting tube 12 are covered by the light blocking films 50C and 50D, lowering of the coldest spot temperatures of root portions of the electrodes is suppressed by the thermal energy of blocked light. The luminous efficiency is improved, and the starting performance is enhanced.

FIG. 11 is an enlarged longitudinal section view of an arc tube which is a main portion of a discharge bulb of a third exemplary, non-limiting embodiment of the invention.

In the arc tube 1C of the discharge bulb of the third embodiment, end regions 50E and 50F of the light emitting tube 12 in which the metallizing layers 14a are formed are configured by light blocking ceramics colored in, for example, black, so that only the region which is sandwiched between the end regions 50E and 50F that is a pair of light blocking portions emits light or functions as the light emitting portion 12c. As a result, the light-dark boundaries of the end portions in the longitudinal direction of the light emitting portion 12c are made clear (the contrast of the light emitting portion 12c is distinct), and the luminous distribution can be easily controlled by the effective reflecting surfaces 101a and 101b of the reflector 100.

The axial lengths of the end regions 50E and 50F serving as light blocking portions are equal to the widths d′ of the light blocking films 50C and 50D in the second embodiment.

The other portions are identical with those of the second embodiment, and denoted by the same reference numerals. Therefore, their duplicated description will be omitted.

FIG. 12 is an enlarged longitudinal section view of an arc tube which is a main portion of a discharge bulb of an exemplary, non-limiting fourth embodiment of the invention.

In the second and third embodiments, the light blocking films 50C and 50D, and the light blocking portions 50E and 50F, respectively, are disposed directly on the light emitting tube 12. By contrast, in the fourth embodiment, light blocking portions 50G and 50H which block light leaking from the sealed portions 12a and 12b of the light emitting tube 12 constituting an arc tube 11D are configured by cylindrical members made of a metal (such as molybdenum), and which cover end portions (the sealed portions 12a and 12b) of the light emitting tube 12, and fixed and integrated by welding with the outer peripheries of the molybdenum pipes 14 fixed to the light emitting tube 12.

The other portions are identical with those of the second and third embodiments, and denoted by the same reference numerals. Therefore, their duplicated description will be omitted.

In the fourth embodiment, the metal cylindrical members which are the light blocking portions 50G and 50H are welded and fixed to the molybdenum pipes 14. Alternatively, light blocking portions which block light leaking from the sealed portions 12a and 12b of the light emitting tube 12 may be configured by ceramic cylindrical members which cover end portions (the sealed portions 12a and 12b) of the light emitting tube 12, and are welded and fixed to the lead wires 18a and 18b extending from the molybdenum pipes 14.

In the first to fourth embodiments, the light blocking portions 50A, 50B, 50C, 50D, 50E, 50F, 50G, and 50H disposed on either of the arc tube and the glass shroud 20 are formed over the whole circumference. With respect to the upper effective reflecting surface 101a, at least the rear end of the light emitting tube 12 (the effective light emitting portion 12c) corresponding to the end portion of the light source image on the side of the elbow portion E of the clear cutoff line, when the light source image is projected onto the luminous distribution screen S1, is cleared.

With respect to the lower effective reflecting surface 101b, similarly, at least the front end of the light emitting tube 12 (the effective light emitting portion 12c) corresponding to the end portion of the light source image on the side of the elbow portion E, when the light source image is projected onto the luminous distribution screen S1, is clear.

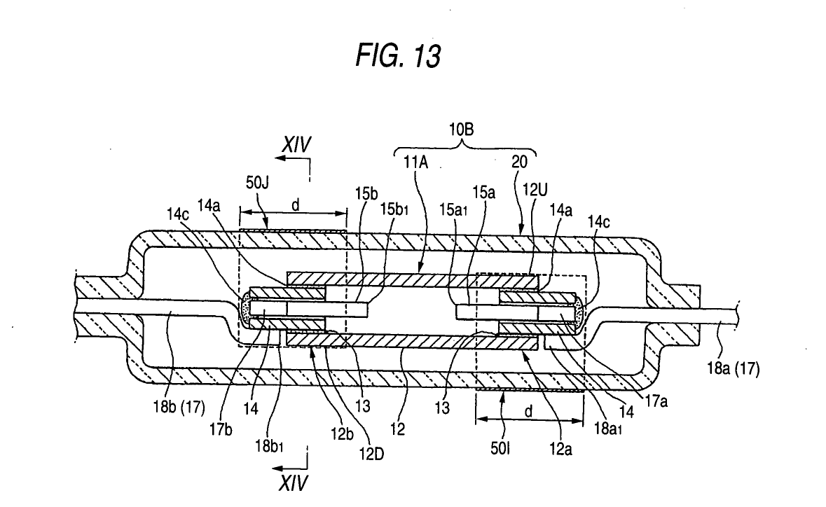

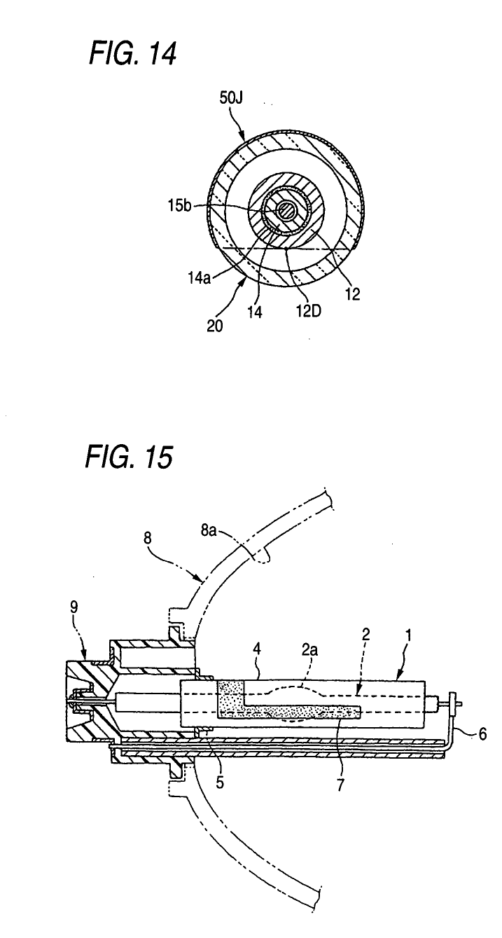

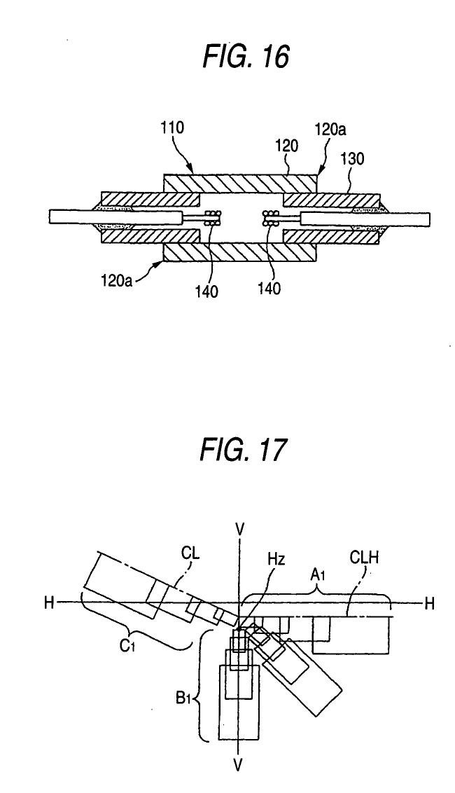

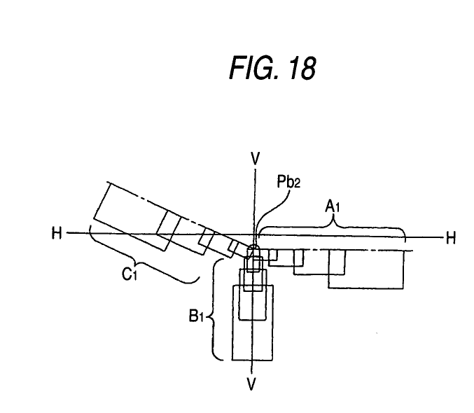

As in an arc tube body 10B of a discharge bulb of a fifth exemplary, non-limiting embodiment shown in FIGS. 13 and 14, a rear end light blocking film 50J of the glass shroud 20, which is opposed to the rear end sealed portion 12b of the light emitting tube, may extend from the upper side in the circumferential direction to positions which horizontally coincide with the lowermost position 12D of the sealed portion 12b of the light emitting tube. By contrast, a front end light blocking film 50I of the glass shroud 20, which is opposed to the front end sealed portion 12a of the light emitting tube, may extend from the lower side in the circumferential direction to positions which horizontally coincide with the uppermost position 12U of the sealed portion 12a of the light emitting tube.

The embodiments described above are configured so that luminous distribution of a low beam is formed by both the upper and lower effective reflecting surfaces 101a and 101b of the reflector 100. When the lower reflecting surface of the reflector 100 is used for forming luminous distribution to illuminate the near side of a vehicle which is lower in level than the clear cutoff line CL, and luminous distribution of a low beam is formed by using only the upper reflecting surface 101a of the reflector 100, it is necessary to dispose only the light blocking portion which blocks light leaking from the rear end sealed portion 12b of the light emitting tube 12.

In the embodiments described above, all the discharge bulbs have the structure in which the arc tube, and the glass shroud surrounding the arc tube, are placed in front of the base 30, and are configured so that the light blocking portions are disposed on one of the arc tube, and the glass shroud. Alternatively, light blocking portions may be disposed on both the arc tube and the glass shroud.

In the embodiments described above, the discharge bulbs have the structure in which the arc tube, and the glass shroud surrounding the arc tube are placed in front of the base 30. Alternatively, the discharge bulbs may be structured so that the glass shroud is not disposed.

In the discharge bulbs of the foregoing embodiments, the support of the arc tube on the base 30 is performed only by the lead wires 18a and 18b. To provide resistance to a jarring force, front and rear end portions of the light emitting tube 12 may be supported by support members made of a metal or the like, and the support members may have a function as a light blocking portion which blocks light leaking from the sealed portions of the light emitting tube. This configuration has an advantage that additional production steps of disposing the light blocking portions, such as an application step can be omitted.

The present invention has various advantages. For example, but not by way of limitation, it is possible to form adequate luminous distribution in which the hot zone exists in the vicinity of the clear cutoff line to attain excellent remote visibility of the driver, and which does not form glare light for an oncoming vehicle or the like.

Also, a predetermined low beam is formed by the two or upper and lower effective reflecting surfaces of a reflector, and hence adequate luminous distribution which provides more excellent remote visibility of the driver can be formed.

Further, lowering of the coldest spot temperature of a root portion of an electrode is suppressed by the thermal energy of light blocked by the light blocking portion. Hence an arc tube having an excellent starting performance can be obtained.

Additionally, the axial width of the light blocking portion is formed in the predetermined width from the sealed portion of the light emitting tube to the tip end of the electrode at the maximum, so that an arc tube which can ensure luminous distribution of a sufficient light quantity can be obtained.

Still further, it is possible to form adequate luminous distribution in which the hot zone exists in the vicinity of the clear cutoff line, to attain excellent remote visibility of the driver, and which does not form glare light for an oncoming vehicle or the like.

The light blocking portion can also be easily formed, and steps of producing the discharge bulb can be simplified, whereby the discharge bulb can be correspondingly economically provided.

The present invention is not limited to the specific above-described embodiments. It is contemplated that numerous modifications may be made to the present invention without departing from the spirit and scope of the invention as defined in the following claims.

I/we claim:

1. A discharge bulb, comprising:
an arc tube fixedly positioned and forwardly elongating from an insulating base positioned behind said arc tube;
a ceramic, straight, and cylindrical light emitting tube positioned in said arc tube, said light emitting tube having sealed end portions to form an enclosed space therein; and
electrodes opposingly disposed in said light emitting tube where said enclosed space is filled with a light emitting substance and a starting rare gas; and wherein
a first light blocking portion is disposed on a first portion of said arc tube that corresponds to at least a rear one of the sealed end portions of said light emitting tube, said light blocking portion extending over at least a predetermined range from an upper side in a circumferential direction to both lateral sides of said light emitting tube.

2. The discharge bulb according to claim 1, further comprising:
a light blocking portion positioned on a second portion that corresponds to a front one of the sealed end portions of said light emitting tube, and said light blocking portion extends over at least a predetermined range, from a lower side in the circumferential direction to both of said lateral sides of said light emitting tube.

3. The discharge bulb of claim 2, wherein said second light blocking portion is formed in a predetermined width from the second position corresponding to said sealed portion of said light emitting tube, up to a maximum width substantially at a tip end of corresponding one of said electrodes.

4. The discharge bulb of claim 1, wherein said first light blocking portion is formed in a predetermined width from the first position corresponding to said sealed portion of said light emitting tube, up to a maximum width substantially at a tip end of corresponding one of said electrodes.

5. The discharge bulb of claim 1, wherein said light blocking portion on a rear end side of at least one of said arc tube and said glass shroud extends in the circumferential direction to positions that horizontally coincide in level with an lowermost position of said rear end sealed portion of said light emitting tube.

6. The discharge bulb of claim 1, wherein said light blocking portion on a front end side of at least one of said arc tube and said glass shroud extends in the circumferential direction to positions that horizontally coincide in level with a upperrmost position of said front end sealed portion of said light emitting tube.

7. The discharge bulb of claim 1, wherein said light blocking portion is disposed in the circumferential direction over a whole circumference of at least one of said arc tube and said glass shroud.

8. A discharge bulb, comprising:
an arc tube is fixedly positioned so as to elongate from an insulating base positioned behind said arc tube;
a ceramic, straight, and cylindrical light emitting tube positioned in said arc tube and having sealed end portions to form an enclosed space therein; and
electrodes opposingly disposed in said light emitting tube, wherein said enclosed space is filled with a light emitting substance and a starting rare gas; and
an ultraviolet-ray blocking glass shroud surrounding said light emitting tube and positioned around said arc tube, wherein, in at least one of said arc tube and said glass shroud, a light blocking portion is positioned corresponding to at least a rear end sealed portion among front and rear end sealed portions of said light emitting tube, said light blocking portion extending over at least a range from an upper side in a circumferential direction to both lateral sides.

9. The discharge bulb according to claim 3, further comprising:
a light blocking portion positioned corresponding to said front end sealed portion of said light emitting tube, in at least one of said arc tube and said glass shroud, wherein said light blocking portion extends over at least a predetermined range from a lower side in the circumferential direction to both of said lateral sides.

10. The discharge bulb of claim 9, wherein said second light blocking portion is formed in a predetermined width from the second position corresponding to said sealed portion of said light emitting tube, up to a maximum width substantially at a tip end of corresponding one of said electrodes.

11. The discharge bulb of claim 8, wherein said first light blocking portion is formed in a predetermined width from the first position corresponding to said sealed portion of said light emitting tube, up to a maximum width substantially at a tip end of corresponding one of said electrodes.

12. The discharge bulb of claim 8, wherein said light blocking portion on a rear end side of at least one of said arc tube and said glass shroud extends in the circumferential direction to positions that horizontally coincide in level with an lowermost position of said rear end sealed portion of said light emitting tube.

13. The discharge bulb of claim 8, wherein said light blocking portion on a front end side of at least one of said arc tube and said glass shroud extends in the circumferential direction to positions that horizontally coincide in level with a uppermost position of said front end sealed portion of said light emitting tube.

14. The discharge bulb of claim 8, wherein said light blocking portion is disposed in the circumferential direction over a whole circumference of at least one of said arc tube and said glass shroud.

15. A discharge bulb, comprising:
an arc tube fixedly positioned and forwardly elongating from an insulating base positioned behind said arc tube;
a ceramic, straight, and cylindrical light emitting tube positioned in said arc tube and having sealed end portions to form an enclosed space therein;
electrodes opposingly disposed in said light emitting tube, where said enclosed space is filled with a light emitting substance and a starting rare gas; and
means for positioning a hot zone of a luminous distribution at a cutoff line of said luminous distribution, and substantially reducing a glare light output.

16. The discharge bulb of claim 15, said means for positioning and substantially reducing comprising:
a first light blocking portion disposed on a first portion of said arc tube that corresponds to at least a rear one of the sealed end portions of said light emitting tube, wherein said light blocking portion extends over at least a predetermined range from an upper side in a circumferential direction to both lateral sides of said light emitting tube.

17. The discharge bulb according to claim 16, said means for positioning and substantially reducing further comprising:
a light blocking portion positioned corresponding to said front end sealed portion of said light emitting tube, in at least one of said arc tube and said glass shroud, wherein said light blocking portion extends over at least a predetermined range from a lower side in the circumferential direction to both of said lateral sides.

18. The discharge bulb of claim 16, wherein said second light blocking portion is formed in a predetermined width from the second position corresponding to said sealed portion of said light emitting tube, up to a maximum width substantially at a tip end of corresponding one of said electrodes, and wherein said first light blocking portion is formed in a predetermined width from the first position corresponding to said sealed portion of said light emitting tube, up to a maximum width substantially at a tip end of corresponding one of said electrodes.

19. The discharge bulb of claim 16, wherein said light blocking portion on a rear end side of at least one of said arc tube and said glass shroud extends in the circumferential direction to positions that horizontally coincide in level with an lowermost position of said rear end sealed portion of said light emitting tube,
said light blocking portion on a front end side of at least one of said arc tube and said glass shroud extends in the circumferential direction to positions that horizontally coincide in level with a uppermost position of said front end sealed portion of said light emitting tube, and
said light blocking portion is disposed in the circumferential direction over a whole circumference of at least one of said arc tube and said glass shroud.

20. The discharge bulb of claim 16, further comprising:
an ultraviolet-ray blocking glass shroud surrounding said light emitting tube and positioned around said arc tube, wherein, in at least one of said arc tube and said glass shroud.
